(19) United States
(12) Patent Application Publication
(10) Pub. No.: US 2004/0252333 A1
(43) Pub. Date: Dec. 16, 2004

(54) Mobile communication device printing

(76) Inventors: Leo Robert Blume, Palo Alto, CA (US); Phillip A. McCoog, Portland, OR (US); Rabindra Pathak, Vancouver, WA (US); Michael Strittmatter, San Francisco, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/463,385

(22) Filed: Jun. 16, 2003

(51) Int. Cl. G06F 15/00

(52) U.S. Cl. 358/1.15

(57) ABSTRACT

A cellular telephone printing system is provided. The print system includes a discovery logic configured to identify an image forming device with which the system may interact, a content transforming logic configured to prepare content for delivery to the image forming device in a form useable by the image forming device, and a print managing logic configured to manage providing the content to the image forming device.

It is emphasized that this abstract is provided to comply with the rules requiring an abstract that will allow a searcher or other reader to quickly ascertain the subject matter of the application. It is submitted with the understanding that it will not be employed to interpret or limit the scope or meaning of the claims 37 CFR 1.72(b).

### TECHNICAL FIELD

The systems, methods, storage media, application programming interfaces (API), and so on described herein relate generally to mobile communication devices and more particularly to print services associated with mobile communication devices.

### BACKGROUND

Mobile communication devices have conventionally had limited or no print capabilities.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example mobile communication device print system.

FIG. 2 illustrates an example mobile communication device print system.

FIG. 3 illustrates an example mobile communication device print system.

FIG. 4 illustrates an example mobile communication device print system.

FIG. 5 illustrates an example mobile communication device print system.

FIG. 6 illustrates an example mobile communication device print method.

FIG. 7 illustrates an example mobile communication device print method.

FIG. 8 illustrates an example mobile communication device print method.

FIG. 9 illustrates an example mobile communication device print method.

FIG. 10 illustrates an example image forming device that may interact with a system or method for mobile communication device printing.

FIG. 11 illustrates an example data packet associated with systems and methods for mobile communication device printing.

FIG. 12 illustrates an example application programming interface (API) associated with systems and methods for mobile communication device printing.

FIG. 13 illustrates an example wireless mobile communication device.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks and so on. Volatile media may include dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, for example, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal”, as used herein, includes but is not limited to one or more electrical or optical signals, analog or digital, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

“User”, as used herein, includes but is not limited to one or more persons, software, computers, logics, or other devices, or combinations of these.

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

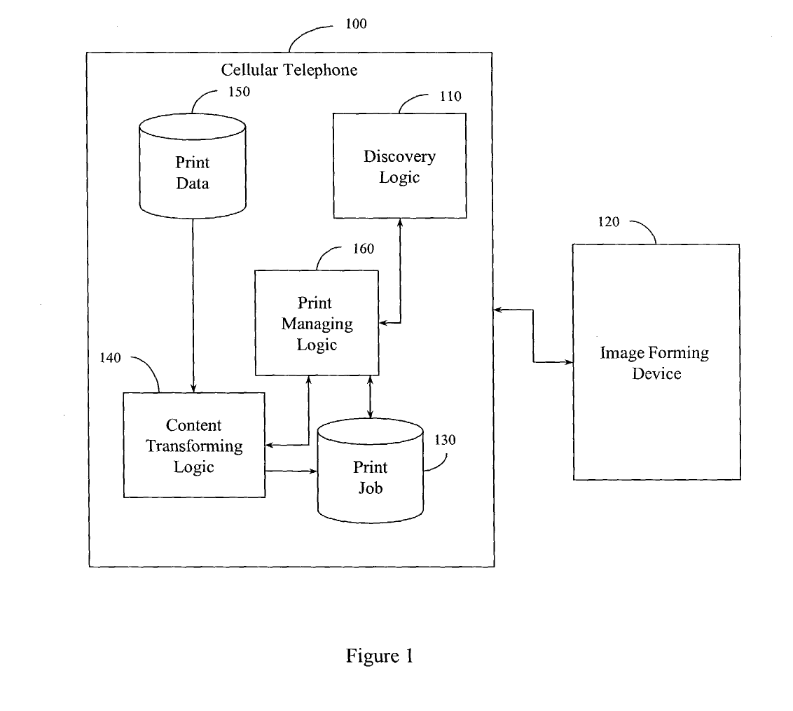

FIG. 1 illustrates an example print system for a mobile communication device like a cellular telephone 100. The system includes a discovery logic 110 configured to identify an image forming device 120 to which the system can provide an image forming device ready print job 130. The discovery logic 110 may identify the image forming device 120 using various methods including, but not limited to, Bluetooth protocols, and IEEE 802.11 protocols. Bluctooth refers to short-range radio technology concerned with data and/or computer communications. Information concerning the Bluetooth specification and protocols can be found, for example, at www.bluetooth.org. IEEE 802.11 refers to a family of specifications developed by the Institute of Electrical and Electronics Engineers (IEEE) for wireless local area network (LAN) technology. Thus, the discovery logic 110 may find the image forming device 120 without reference to intermediaries like a website that stores a model of a communication network. Similarly, the discovery logic 110 may find the image forming device 120 directly through wireless transmissions.

The image forming device 120 may be, for example, a printer. It will be appreciated that the print system, as well as other systems shown in other figures, can also apply to other mobile communication devices, for example, a wireless network PDA, or a camera-enabled mobile phone. Thus, the print job 130 may be a printer-ready form of a file, a message, an image, an object, an email, and so on. In one example, the system provides the print job 130 in the form of “printer-ready bits” (e.g., a rendered image, a bitmap), while in another example, the system provides the print job 130 in the form of “printer-ready instructions” (e.g., based on PostScript instructions, XHTML-Print (Extensible Hypertext Markup Language) instructions, other markup language, a page description language, or other device-independent format). Printer-ready bits may include, for example, data rendered into a format acceptable to a printer where the printer can print the data without further rendering. Printer-ready instructions may include, for example, data prepared and packaged into a file that is in a format acceptable to a printer where the printer can print the data by processing the instructions included with the data. Thus printer-ready bits and printer-ready instructions refer to an item that has a data representation acceptable to and/or usable by a printer.

The system may also include a content transforming logic 140 configured to transform a print data 150 into the image forming device ready print job 130. Since the cellular telephone 100 may take forms like a cellular telephone and a camera-enabled mobile phone, the print data 150 may take various forms including, but not limited to, a file, a message, an image, an object, and an email. The system may also include a print managing logic 160 configured to manage providing the image forming device ready print job 130 to the image forming device 120. Thus, the print managing logic 160 may undertake tasks like, establishing a communication link with the image forming device 120, managing the communication link with the image forming device 120, providing the print job 130 to one or more communication components for transmission to the image forming device 120, and receiving status and/or control information from the image forming device 120 concerning the processing of the print job 130. The print managing logic 160 may also control and/or interact with the content transforming logic 140 to facilitate transforming the print data 150 into the print job 130 pursuant to image forming device 120 capabilities discovered by the discovery logic 110.

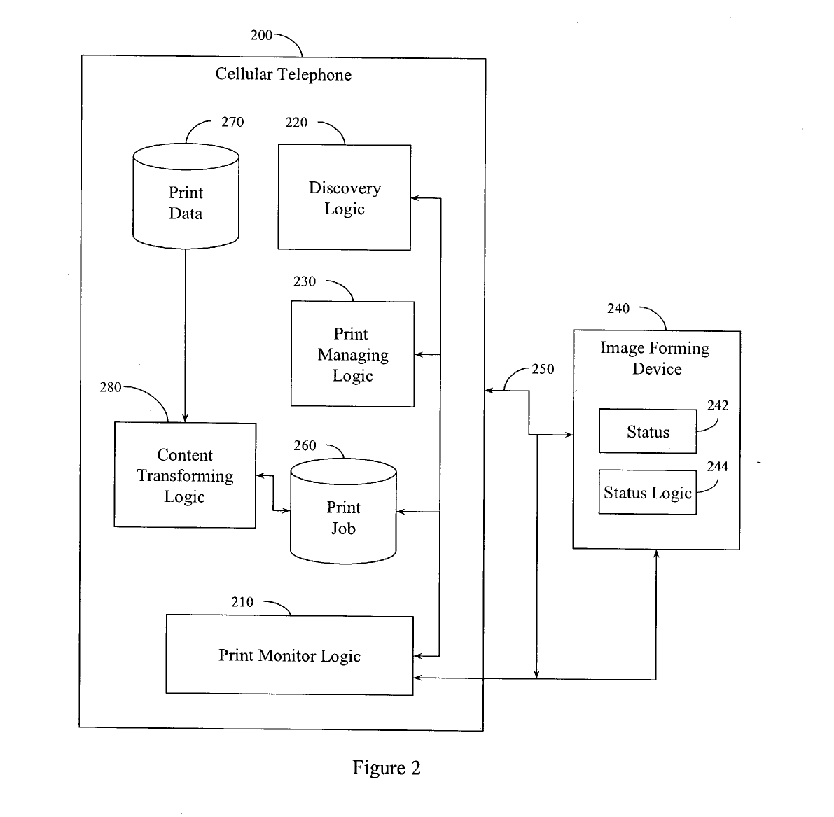

FIG. 2 illustrates an example cellular telephone 200 with a print system. The system includes a print monitor logic 210 configured to monitor one or more of, processing performed by a discovery logic 220, processing performed by a print managing logic 230, processing performed by an image forming device 240, a communication link 250 between the system and the image forming device 240, the processing of a print job 260 and content transforming performed by a content transforming logic 280. Monitoring the processing performed by the discovery logic 220 can include tracking whether the discovery logic 220 has located an image forming device 240 to which a print job 260 can be transmitted, tracking whether the discovery logic 220 has advertised one or more print service capabilities of the system, and tracking whether the discovery logic 220 has received any requests for print services from an external mobile communication device.

In one example, the print monitor logic 210 is configured to report on one or more of, the transformation of a print data 270 to the print job 260, the transmission of the print job 260 to the image forming device 240, and the processing of the image forming device 240. To facilitate reporting on the transformation of the print data 270 to the print job 260, the print monitor logic 210 may also monitor processing performed by the content transforming logic 280. For example, the print monitor logic 210 may track the amount of data in the print data 270 that has been converted to data in the image forming device ready print job 260.

In one example, to facilitate monitoring the various components, the print monitor logic 210 may be operably connected to one or more of the discovery logic 220, the print managing logic 230, the content transforming logic 280, and the image forming device 240. To facilitate being monitored, the image forming device 240 may include a memory 242 configured to store status information associated with the image forming device 240 and/or the processing of one or more print jobs 260 transmitted to the image forming device 240 for processing. The print monitor logic 210 may generate, for example, a query that is transmitted to the image forming device 240 via communication link 250. The image forming device 240 may, therefore, include a logic 244 configured to receive a status request, access the status information stored in the memory 242, and selectively provide the status information to the print monitor logic 210. Additionally, and/or alternatively, the image forming device 240 may be configured to initiate providing status information from the memory 242 to the print monitor logic 210 and/or other logics.

In one example, the print monitor logic 210 is configured to control components including, but not limited to the discovery logic 220, the image forming device 240, the content transforming logic 280, the print managing logic 230, and the communication link 250 between the system and the image forming device 240. The controlling can include, for example, pausing the image forming device 240, delaying the delivery of the print job 260 to the image forming device 240, canceling the delivery of the print job 260 to the image forming device 240, delaying the processing of the print job 260 by the image forming device 240, and canceling the processing of the print job 260 by the image forming device 240. The print monitor logic 210 may take these actions under programmatic and/or user control, for example.

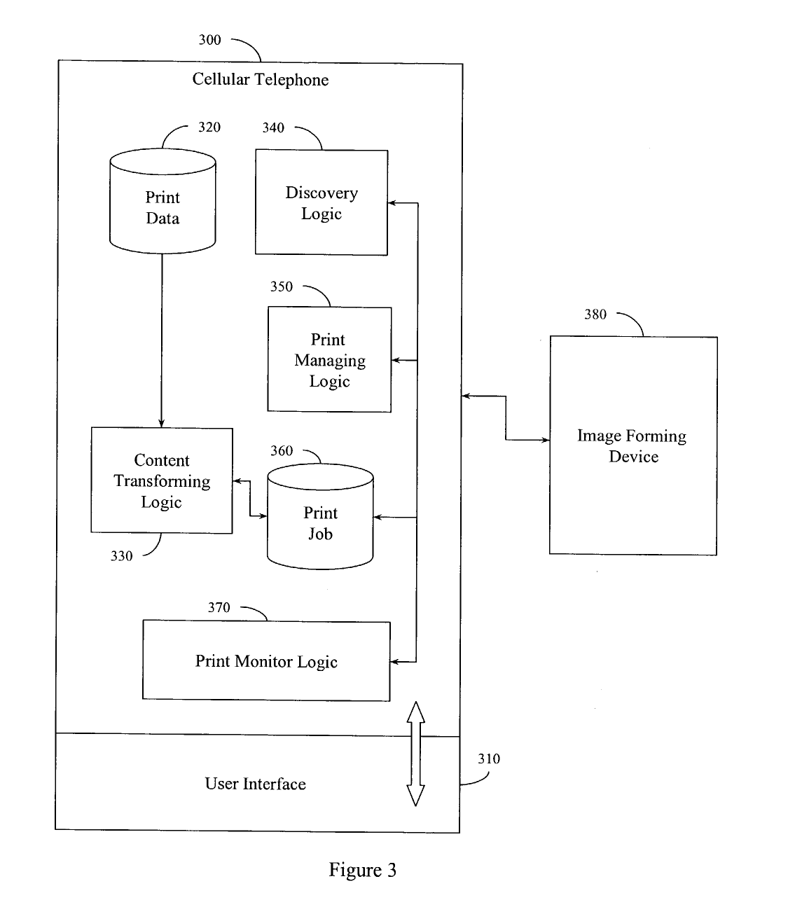

FIG. 3 illustrates an example cellular telephone 300 print system that includes a user interface 310 configured to manage parameters and/or values for parameters associated with mobile communication device printing systems and methods. In one example, the user interface 310 is configured to manage parameters including, but not limited to, a print data 320 parameter, a content transforming logic 330 parameter, a discovery logic 340 parameter, a print managing logic 350 parameter, a print job 360 parameter, a print monitor logic 370 parameter, an image forming device 380 parameter, and a communication parameter.

In one example, the print data 320 parameter may be related to identifying attributes of the print data 320. The attributes may include, but are not limited to the print data 320 type, the print data 320 name, the print data 320 size, the print data 320 location, and the print data 320 format. For example, the print data 320 parameter may provide information that a certain print data 320 is a Hypertext Markup Language (HTML) file named “message one” that is 2K bytes in size, located on a file system on the cellular telephone 300 and that it is in HTML version 2.x. Thus, the user interface 310 can facilitate identifying files, for example, that the cellular telephone 300 can process. In another example, the print data 320 parameter may be related to security and thus may control whether the print data 320 may be accepted from an external mobile communication device for print servicing by the cellular telephone 300. Thus, the user interface 310 can facilitate controlling access to the print services offered by the print system on the cellular telephone 300.

The image forming device 380 parameter can be related to, for example, an image forming device 380 address, an image forming device 380 type, and an image forming device 380 capability. By way of illustration, the user interface 310 may be employed to provide the cellular telephone 300 print system with information about an image forming device 380 that is located at a certain network address, either logical or physical, and that has certain capabilities (e.g., pages per minute, color, quality, security) because it is of a certain type (e.g., model X).

In another example, the print job 360 parameter may be related to attributes including, but not limited to, a print job 360 size, a print job 360 source, a print job 360 destination, a print job 360 type, a print job 360 format, a print job 360 delivery time, and a print job 360 identifier. By way of illustration, the user interface 310 may be employed to transfer information about a print job 360 that a user wants printed at a specific image forming device 380, which would be the print job 360 destination. By way of further illustration, the user interface 310 may also be employed to transfer information that the print job 360 is called “print job one”, (identifier), that the print job 360 is an XHTML file (format), and that the user would like the print job 360 printed by noon on the day it is submitted (a delivery time).

The discovery logic 340 parameter may be related to attributes like, a discovery protocol, a discovery persistence, a discovery initiating control value, and a discovery control logic 340 identifier. By way of illustration, a discovery logic 340 may be able to discover image forming devices and/or external mobile communication devices using one or more protocols (e.g., Bluetooth, IEEE 802.11). Similarly, the discovery logic 340 may be able to advertise the print system capabilities by one or more protocols (e.g., Bluetooth, IEEE 802.11). Thus, the user interface 310 can be employed to program the discovery logic 340 to employ a certain discovery protocol or advertising protocol. By way of further illustration, the discovery logic 340 may be configured to continue trying to discover components like an image forming device 380 for a pre-determined, configurable period of time. For example, a user may program the discovery logic 340 in a cellular telephone 300 to look for an image forming device 380 for one minute. After that period of time has expired, the user may decide to store a print job 360 and try again later. Thus, the user may not be burdened with waiting for an undesired period of time to print a print job 360.

In another example, the communication parameter may be related to attributes including, but not limited to, a communication protocol, a communication path, a communication type, a communication priority, and a communication speed. For example, the user interface 310 can be employed by a user to indicate that they would like a print job 360 to be communicated to an image forming device 380 using a packet based communication protocol that includes packet confirmation, that the communication use at least 64 bit encryption, and that the communication occur at a speed above a certain pre-determined, configurable threshold.

A print monitor logic 370 parameter may be related to attributes including, but not limited to, identifying a set of components for the print monitor logic 370 to monitor, identifying a set of logics to which the print monitor logic 370 will report, and identifying a set of conditions that will trigger a print monitor logic 370 action, for example. By way of illustration, while the print monitor logic 370 may be able to monitor, among other things, the content transforming logic 330, the discovery logic 340, the print manager logic 350, and the image forming device 380, a user may not be interested in monitoring all these components. Thus, the user interface 310 can be employed to direct which components the print monitor logic 370 will monitor. Similarly, while the print monitor logic 370 may be able to monitor actions associated with transmitting the print job 360 to the image forming device 380 like start of transmission, end of transmission, signal strength on the communication link, print queue priority, and so on, the user may be interested in knowing when the print job 360 is complete. Thus, the user interface 310 can be employed to establish values that control which actions the print monitor logic 370 will report on. This flexibility facilitates the print monitor logic 370 acquiring and/or reporting information like, was a print job 360 transmitted, to what image forming device 380 was it delivered, when was it received, and so on. Furthermore, the print monitor logic 370 may acquire and/or provide information like is a print job 300 printing, waiting, complete, x % complete and is a printer working, busy, low on ink, low on paper, jammed, off-line, and so on.

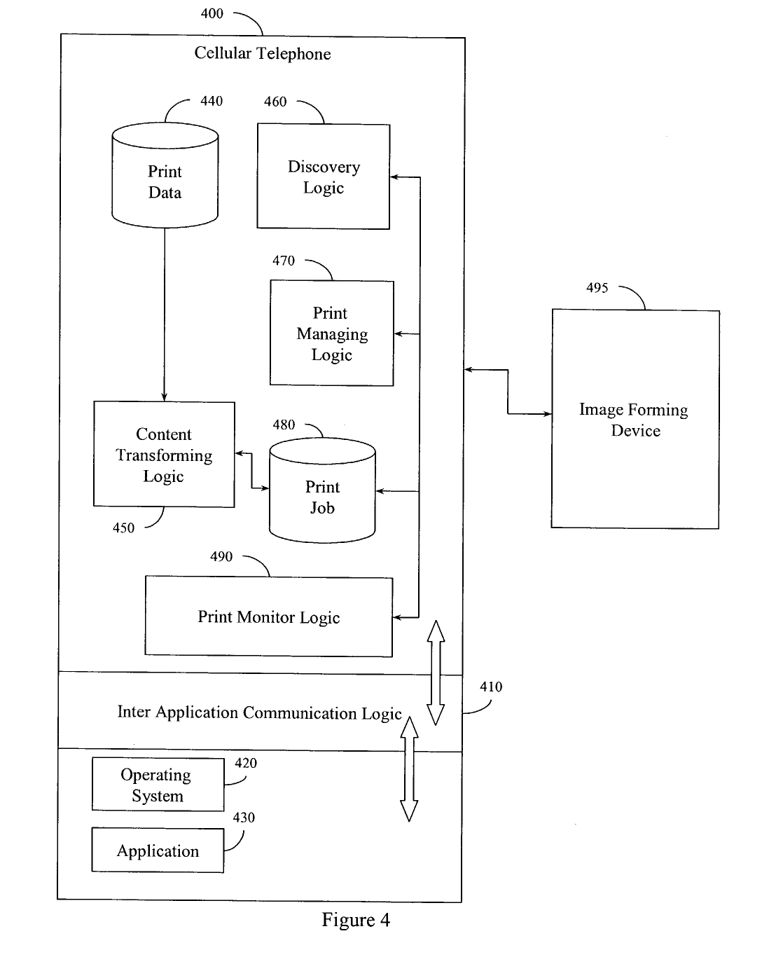

FIG. 4 illustrates an example cellular telephone 400 with a print system. The system includes an inter-application communication logic 410 configured to interface between the system and components on the cellular telephone 400 including, but not limited to, an operating system 420, and one or more application(s) 430. The application(s) 430 can include, but are not limited to, a calendar application, a contacts application, an address book application, a game application, a calculator application, a word processing application, and a spread-sheeting application. The interfacing can include employing, to the print system, functionalities provided by the operating system 420 and/or the application(s) 430.

FIG. 4 thus illustrates that in one example, a cellular telephone 400 may have a print system that is a stand alone application that is itself responsible for interfacing with hardware and/or software on the cellular telephone 400 to implement print services. This type of stand alone application may be added to a cellular telephone 400 that is not print-enabled. For example, the stand alone application may be installed from a download into the cellular telephone 400, installed as a firmware upgrade to the cellular telephone 400, and so on. The stand alone application is an application with which a user may interact directly. Thus, the user may start/stop the application and/or use its built-in graphical user interface, menu system and/or command structure directly. The user would likely be aware that they were interacting directly with the stand alone application.

FIG. 4 also illustrates that in one example, a cellular telephone 400 may have a print system that is more integrated with the operating system 420 and one or more of the application(s) 430 existing on the cellular telephone 400. To have a more integrated print system, the integrated print system can be configured to employ the inter application communication logic 410 to transmit signals to the operating system 420 and/or application(s) 430 to employ functionalities provided by the operating system 420 and/or application(s) 430. The functionalities may include, but are not limited to, a cut and paste function, a copy and paste function, a send function, a drag and drop function, a menu function, a dialog function, and an icon presentation function. When employing the integrated application, the user will more likely interact indirectly with the cellular telephone 400 print systems and methods. For example, a user may drag a file onto a print icon, thus invoking operating system 420 functionality while employing the print system.

While a print icon is described, it is to be appreciated that the print system can be integrated with the operating system 420 and/or applications 430 by other techniques including, but not limited to, adding a print entry to a menu, adding a print entry to a dialog box, and adding a new destination (e.g., printer) to a “send” feature.

By way of illustration, a stand alone application may be programmed with its own user interface (e.g., menu system) that facilitates a user identifying a print data 440 and programming a content transforming logic 450 to produce a print job 480. Similarly, the stand alone application may be programmed with its own user interface that facilitates controlling a discovery logic 460, a print managing logic 470, and a print monitor logic 490. However, an integrated application may be programmed that employs various functions provided by the operating system 420 and/or application(s) 430. For example, the operating system 420 may provide a drag and drop function that allows a user to select a file, drag it over a target icon and drop it on that target icon to indicate that a certain action is desired. While the stand alone application might include a menu system or command structure for indicating that a certain action is desired, some users may be familiar with the drag and drop method. Thus, the integrated application may employ the inter application communication logic 410 to send a signal and/or data to the operating system 420 to employ the drag and drop functionality of the operating system.

By way of further illustration, a stand alone application may be programmed with its own messaging interface that facilitates a user creating or sending messages concerning a print job 480. However, an integrated application may be programmed that employs a “send” feature built into an application 430 on the cellular telephone 400. Thus, rather than implement its own messaging system, the integrated application may employ the inter application communication logic 410 to transmit data and/or signals to the application 430 that implements the send feature. For example, a pre-existing application on the cellular telephone 400 (e.g. a Photo Album application) can be programmed with a “Send” option in a menu. When the “Send” option is selected, a list of destinations can be displayed to which a user can “Send” a selected image. One of the destinations might be an email application, implying that a user wishes to email the selected image to someone. Another could be a Print feature, implying that the user wishes to print the selected image. Thus, similar to the Drag and Drop feature, the Send feature offers is a different way for the user to indicate what content they want to print. A way that they might already be familiar with from using the feature in one of the existing applications 430.

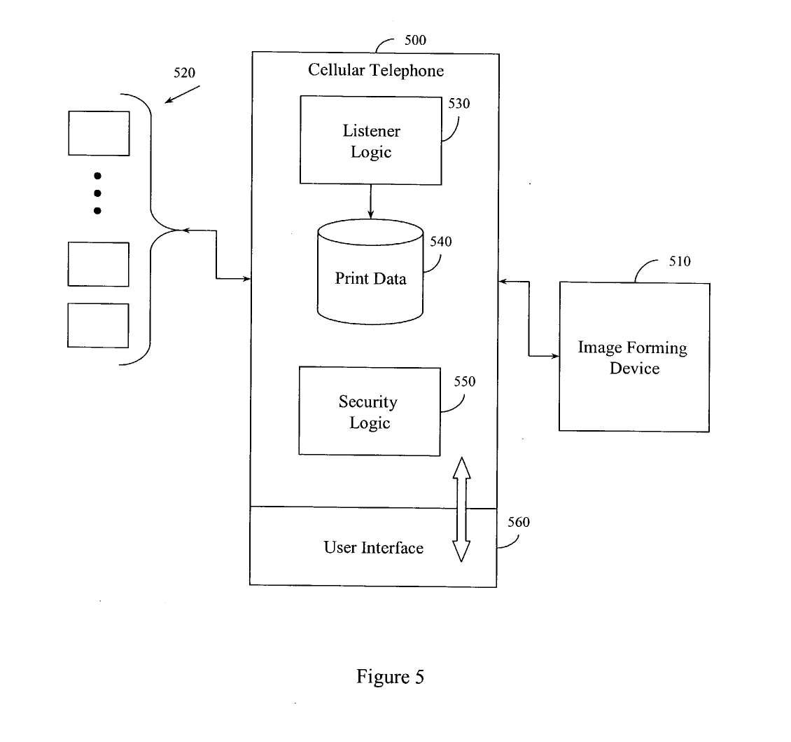

FIG. 5 illustrates an example cellular telephone 500 with a print system that facilitates the cellular telephone 500 acting as a printer server that can make an image forming device 510 available via print services to one or more external mobile communication devices 520. The cellular telephone 500 includes a listener logic 530 configured to receive from one or more external mobile communication devices 520 items including, but not limited to, a content data and a print serve request. The content data can be, for example, a file, a message, an image, an object, an email, and the like. The content data may also be, for example, a link, a universal resource locator (URL), an identifier (e.g., guid) and the like. The print serve request may include information that the external mobile communication device 520 would like the cellular telephone 500 and its print system to handle transforming the content into a print job and transmitting the print job to the image forming device 510. The external mobile communication device 520 may be, for example, a cellular phone, a camera-enabled mobile phone, and the like. The external mobile communication device 520 may communicate with the cellular telephone 500 via, for example, wireless transmissions. In one example, the wireless transmissions are cellular telephone transmissions.

The cellular telephone 500 may store the content data received from the external mobile communication device 520 as a print data 540. The cellular telephone 500 may then transform the print data 540 into a print job and transmit it to the image forming device 510. Therefore, in one example, a print monitor logic, a print managing logic, and a content transforming logic can process the content data into a print job pursuant to the print serve request and provide the print job to the image forming device 510 on behalf of the external mobile communication device 520.

A user of an external mobile communication device 520 may wish to be informed about the status of their print serve request. Thus, in one example, a print monitor logic can be configured to report status associated with a print job related to the external mobile communication device 520 to the external mobile communication device 520. The degree to which the user of the external mobile communication device 520 will be informed can be controlled, for example, by parameters managed through a user interface 560.

Since the cellular telephone 500 may be a wireless device (e.g., cellular phone, camera-enabled mobile phone), the cellular telephone 500 may encounter wireless transmissions from unanticipated and/or unwanted devices. Thus, the cellular telephone 500 and its print system may be programmed to accept print serve requests from some external mobile communication devices 520 and/or users and to reject others. Therefore, in one example, the cellular telephone 500 includes a security logic 550 configured to control one or more of, whether a content data or a print serve request from an external mobile communication device 520 will be accepted. For example, a company may purchase a cellular telephone 500 and a set of related external mobile communication devices 520 for which the company wants the cellular telephone 500 to act as a print server. Thus, the security logic 550 can be configured to accept print serve requests and content data from related external mobile communication devices 520 that belong to the company and to reject requests from other mobile communication devices 520.

The cellular telephone 500 can also include a discovery logic (not illustrated) that can be configured similarly to discovery logic 460 (FIG. 4). Additionally, and/or alternatively, the discovery logic may be further configured to perform actions including, but not limited to, generating a print services advertisement, and accepting from an external mobile communication device 520 a request for a print service advertisement. Thus, the discovery logic facilitates the cellular telephone 500 acting as a print server for the external mobile communication devices 520. By way of illustration, the cellular telephone 500 may be programmed to periodically advertise that it is available to provide print services to external mobile communication devices 520. Thus, as the cellular telephone 500 is transported from place to place, different external mobile communication devices 520 may be made aware of its presence and its print server capabilities. Therefore, external mobile communication devices 520 that are print aware but not print enabled may determine to employ the print services advertised by the cellular telephone 500. Similarly, the discovery logic may be configured to receive and respond to requests for print services advertisements. Again, as the cellular telephone 500 is transported from place to place, or as external mobile communication devices 520 travel from place to place and thus come in range of the cellular telephone 500, various mobile communication devices 520 may have print jobs that they are trying to get printed. Therefore, the external mobile communication devices 520 may periodically generate a request designed to have print enabled mobile communication devices advertise their presence and print capabilities. When an appropriate device with the appropriate capabilities is found, the external communication device 520 may then generate a print request to the cellular telephone 500.

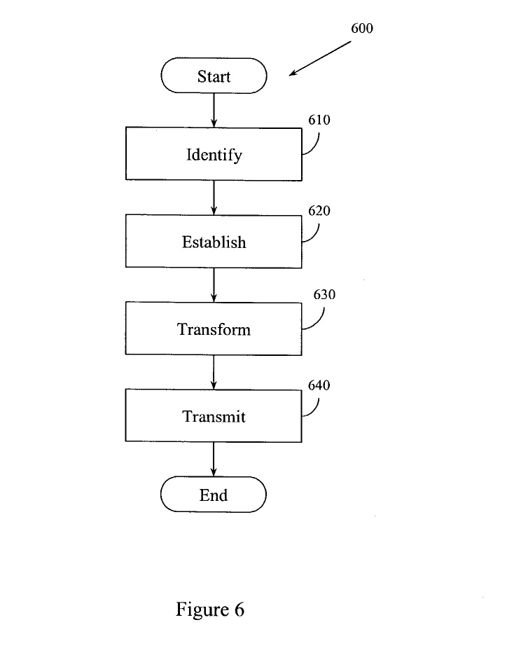

Example methods may be better appreciated with reference to the flow diagrams of FIGS. 6 through 9. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In one example, methodologies are implemented as processor executable instructions and/or operations stored on a computer-readable medium including, but not limited to, an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams, blocks denote “processing blocks” that may be implemented, for example, in software. Additionally and/or alternatively, the processing blocks may represent functions and/or actions performed by functionally equivalent circuits like a digital signal processor (DSP), an application specific integrated circuit (ASIC), and the like.

A flow diagram does not depict syntax for any particular programming language, methodology, or style (e.g., procedural, object-oriented). Rather, a flow diagram illustrates functional information one skilled in the art may employ to fabricate circuits, generate software, or use a combination of hardware and software to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 6 illustrates an example mobile communication device printing method 600. The method 600 includes, at 610, identifying an image forming device to which a mobile communication device can provide a print-ready object (e.g., printer-ready bits, printer-ready instructions). Identifying the image forming device may include employing resource locating functions like those found in protocols like Bluetooth or IEEE 802.11, for example. In one example, the image forming device may be a printer. In another example, the mobile communication device may be a cellular phone or a camera-enabled mobile phone.

The method 600 may also include, at 620, establishing a communication link between the image forming device and the mobile communication device. The communication link may be, for example, a wireless communication link that employs protocols like Bluetooth or IEEE 802.11. In one example, the communication link is a one-way communication link while in another example the communication link is a bi-directional communication link. A bi-directional communication facilitates functionality like the mobile communication device monitoring the status of the image forming device or a print job served up to the image forming device, for example. The communication link may employ, for example, packet switching or circuit switching, and may form, for example, a link in a local area network (LAN), personal area network (PAN), and the like.

The method 600 may also include, at 630, transforming a non-print-ready object on the mobile communication device into a print-ready object on the mobile communication device. The non print-ready object may be, for example, a file, a message, an object, an image, an email, and the like. The print-ready object can be, for example, printer-ready bits, printer-ready instructions, a PostScript file, an XHTML file, a printer definition language file, a bitmap, and the like.

The method 600 may also include, at 640, transmitting the print-ready object from the mobile communication device to the image forming device. It is to be appreciated that the print-ready object may be transmitted over communication links including wireless or wired links. Similarly, it is to be appreciated that the print-ready object may be transmitted using various protocols, speeds, routing methods and so on.

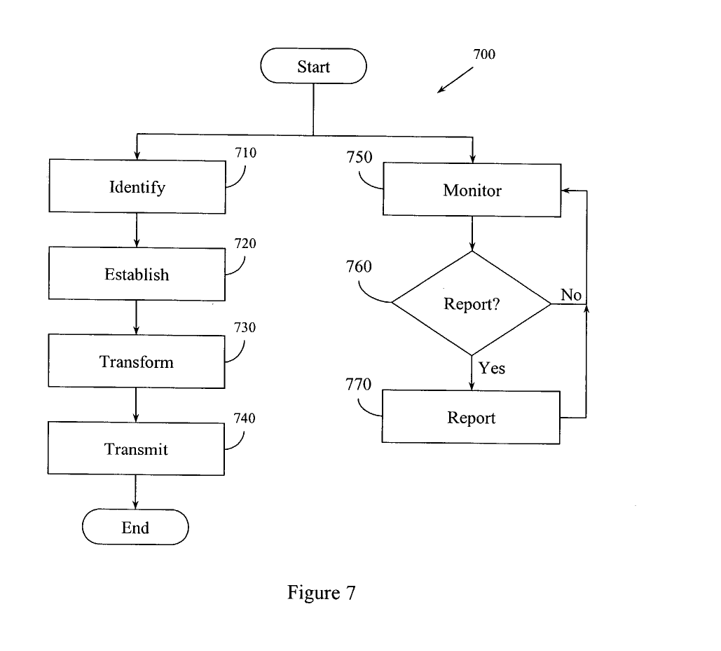

FIG. 7 illustrates an example mobile communication device printing method 700. The method 700 includes, at 710, identifying an image forming device to which a print job can be served up, at 720 establishing a communication link with the image forming device, at 730 transforming a non-print-ready object into a print-ready object and, at 740, transmitting the print-ready object to the image forming device.

The method 700 also includes, at 750, monitoring components or processes including, but not limited to, the communication link, the image forming device, the transformation of the non-print-ready object to the print-ready object and the transmission of the print-ready object to the image forming device. Thus, at 760, the method 700 determines whether a monitor result should be reported. If the determination at 760 is YES, then at 770, the method 700 includes providing a monitoring result to destinations including, but not limited to, a user, a mobile communication device, a log, a data store, a file, and the like.

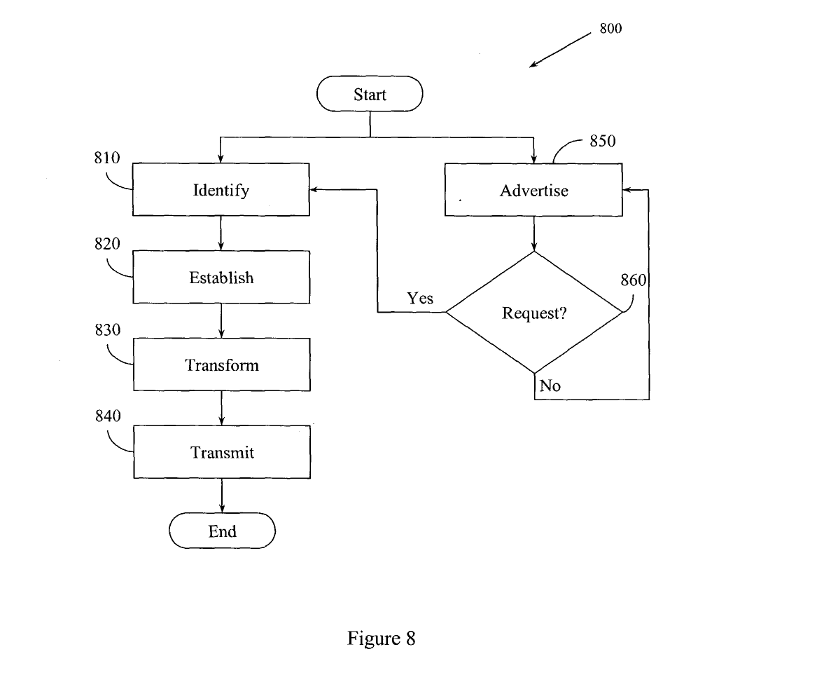

FIG. 8 illustrates an example method 800 employed in mobile communication device printing. The method 800 includes, at 810, identifying an image forming device to which a print job can be served up, at 820, establishing a communication link with the image forming device, at 830, transforming a non-print-ready object into a print-ready object and, at 840, transmitting the print-ready object to the image forming device.

The method 800 also includes, at 850, advertising a print server capability. For example, a mobile communication device might employ a Bluetooth or IEEE 802.11 resource discovery protocol to inform other devices of the print serving capabilities of the mobile communication device. Since the method 800 includes advertising print server capabilities, the method 800 may also include, at 860, receiving a request for a print service capability advertisement and, in response to receiving the request, advertising a print server capability. The method 800 may also include, at 860, receiving a request for a print service (e.g., to content transform a content data and transmit it to an image forming device). The content data may be, for example, a non-printer-ready object that is received from an external mobile communication device. The external mobile communication device may be, for example, a cellular telephone, a camera-enabled mobile phone, and the like.

If a print service request is received at 860, then the method 800 may receive a print content and perform 810 through 840 for the received print content on behalf of the external mobile communication device from which the received print content was received. In this way, the print services of the print-enabled mobile communication device can be employed by print-aware but non-print-enabled mobile communication devices that can communicate with the print serving mobile communication device configured with method 800.

Since the method 800 may receive print serve requests from an external mobile communication device, the method 800 may also include monitoring one or more processes and/or logics involved in serving the print request and then reporting a monitoring result to the external mobile communication device from which the non-printer-ready object was received.

The method 800 includes opportunities for configuration. Thus, the method 800 may also include presenting a configuration parameter choice to a user via a user interface, receiving a configuration parameter value via the user interface, and configuring a mobile communication printing method according to the received configuration parameter values. By way of illustration, the configuration parameters may concern attributes including, but not limited to, content selection criteria, print criteria, and transmission criteria. Content selection criteria may include, but are not limited to, a content name, a content type, a content location, a content size, and a content security level. Similarly, print criteria may include, but are not limited to, a print priority, a print quality, a print size, a print duplex selector, a print orientation selector, and a number of copies selecter. Transmission criteria can include, but are not limited to, a transmission priority, a transmission protocol, and a transmission size.

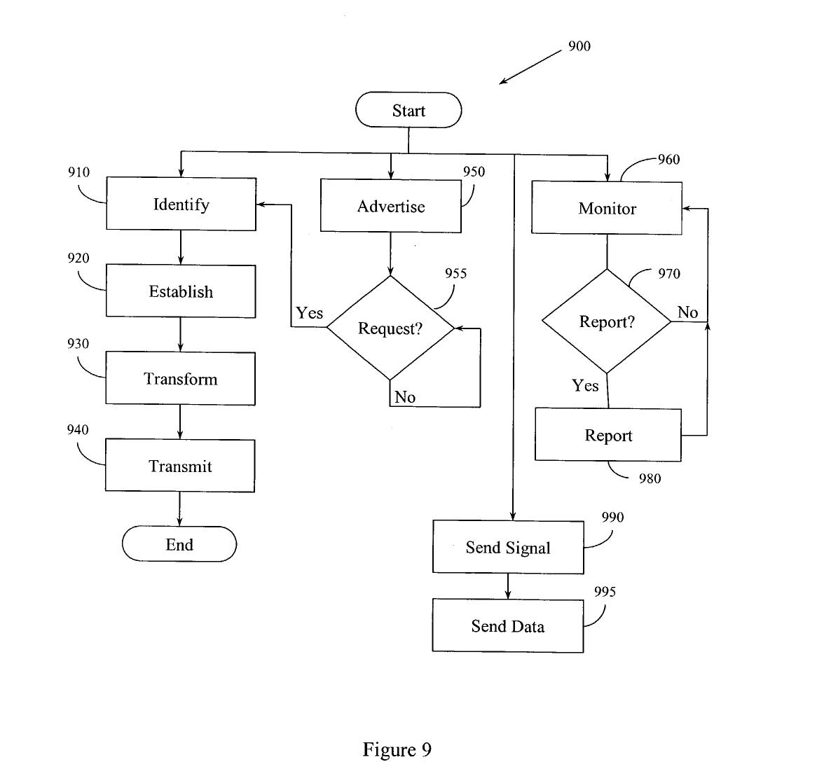

FIG. 9 illustrates an example method 900 for mobile communication device printing that includes methods illustrated in FIGS. 6, 7, and 8. Thus, the method 900 includes, at 910, identifying an image forming device to which a print job can be served up, at 920, establishing a communication link with the image forming device, at 930, transforming a non-print-ready object into a print-ready object and, at 940, transmitting the print-ready object to the image forming device. Similarly, the method 900 may also include, at 950, advertising a print service capability and, at 955, receiving a print serve request or a request for a print service capability advertisement, for example. The method 900 may also include, at 960, monitoring a process and/or logic associated with mobile communication device printing, at 970, receiving requests concerning the monitoring and, at 980, reporting monitoring results.

The method 900 may also include, at 990, sending a signal to destinations including, but not limited to, an operating system on the mobile communication device, and an application on the mobile communication device. Sending the signal(s) facilitates integrating the method 900 with the functionality of the operating system or application. For example, the operating system or application may implement functionalities like icon presentation, drag and drop, send applications, and so on. While a stand alone method for mobile communication device printing may interact directly with hardware, software, and/or drivers on the mobile communication device to implement its own functionality, an integrated method may employ functionality provided by an operating system or application. The signal(s) may cause the operating system and/or applications to, for example, display menus, present drop down or dialog boxes, to display an icon, or to resolve the action and object associated with, for example, dragging and dropping a first icon on a target icon.

At 995, the method 900 includes providing print service data to destinations including, but not limited to, an operating system on the mobile communication device, and an application on the mobile communication device, where the print service data facilitates integrating the method with the operating system or application. For example, the print service data may include an identifier of a file that is dragged and dropped onto a print icon provided by the operating system. In this way the operating system or application can be provided, for example, a printer-ready object and the address of an image forming device to which the printer-ready object is to be transmitted.

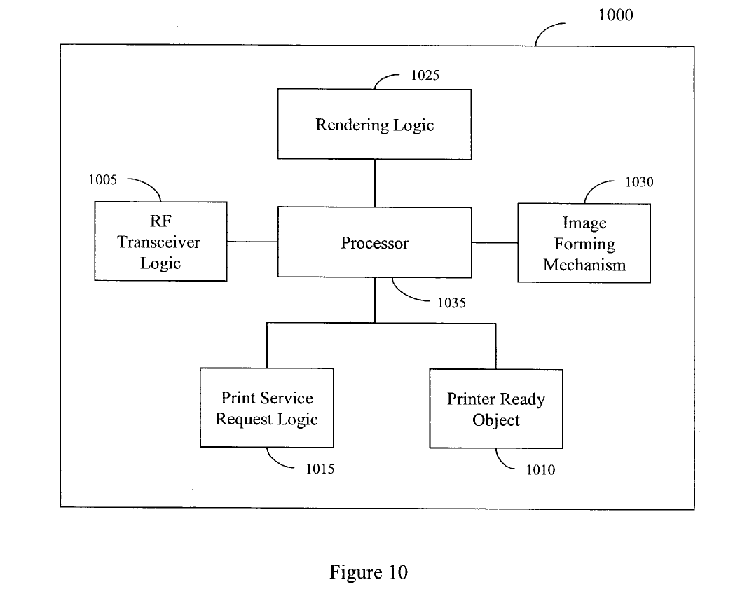

FIG. 10 illustrates an example image forming device 1000 that includes a compatible RF transceiver logic 1005. The image forming device 1000 may include a memory 1010 configured to store a printer-ready object (e.g., file, message, image) received from a mobile communication device and/or information about the object. The image forming device 1000 may be configured to respond to queries from mobile devices relating to print jobs. Therefore, the image forming device 1000 may include a print service request logic 1015 that, when the image forming device 1000 is queried, can transmit information stored in memory 1010 in response to the print service query. Additionally, and/or alternatively, the image forming device 1000 may be configured to initiate transferring information stored in memory 1010.

Additionally, the image forming device 1000 may include rendering logic 1025 configured to generate a printer-ready image from a received non-printer-ready object received, for example, in an imaging request. Rendering varies based on the format of the data involved and the type of imaging device. In general, the rendering logic 1025 converts a high-level object-based description (e.g., the imaging request) into a graphical image for a display or printing (e.g., the print-ready image). For example, one form is ray-tracing that takes a mathematical model of a three-dimensional object or scene and converts it into a bitmap image. Another example is the process of converting HTML into an image for display/printing. In another example, the image forming device 1000 may not have a rendering logic 1025. In this case, a print job would be transmitted to the image forming device 1000 in a print-ready format.

The image forming device 1000 may also include an image forming mechanism 1030 configured to generate an image onto print media from the print-ready image. The image forming mechanism 1030 may vary based on the type of imaging device 1000 and may include a laser imaging mechanism, other toner-based imaging mechanisms, an ink jet mechanism, digital imaging mechanism, or other imaging reproduction engine. A processor 1035 may be included that is implemented with logic to control the operation of the image-forming device 1000. In one example, the processor 1035 includes logic that is capable of executing Java instructions. Other components of the image forming device 1000 are not described herein but may include media handling and storage mechanisms, sensors, controllers, and other components involved in the imaging process.

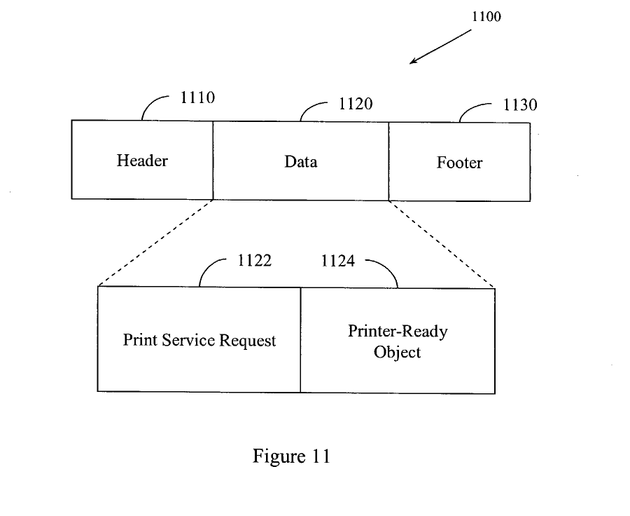

FIG. 11 illustrates an example data packet 1100 associated with systems and methods for mobile communication device printing. Information can be transmitted between various logics and/or communication components associated with mobile communication device printing via a packet like data packet 1100. Example data packet 1100 includes a header field 1110 where information like the length and type of data packet 1100 may be stored. The header field 1110 may also include, for example, a source identifier that identifies, for example, a network or other address of the source of the data packet 1100. The header field 1110 may also include, for example, a destination identifier that identifies, for example, a network or other address of the intended destination for the packet 1100. Thus, the header field 1110 may include, in one example, a cellular telephone address associated with a cellular telephone from which a print job originated and a network address of a printer to which the print job is to be delivered. It is to be appreciated that the source and destination identifiers may take forms including, but not limited to, globally unique identifiers (guids), uniform resource locations (URLs), path names, and so on. Other types and forms of information that can be included in the data packet 1100 that can depend on the communication protocol being employed.

The data field 1120 may include various information intended to be communicated between the source and destination. Example fields 1122 and 1124 are provided. By way of illustration, data associated with requesting that a print job be printed may be stored in field 1122. This data may include, but is not limited to, a print job name, a print job size, a print job format, a print job priority, a print job “print-by” time, and the like. Field 1124 may store a printer-ready object, for example. While a printer-ready object is described in field 1124, it is to be appreciated that data packet 1100 may also transmit objects that are not printer-ready, which may be rendered, for example, on an image forming device. The printer-ready object may be, for example, printer-ready bits (e.g., a rendered image) or printer-ready instructions (e.g., an XHMTL file). The non printer-ready object may be, for example, a file, an image, an object, a message, an email, and the like.

Thus, in one example, a data packet 1100 for communicating mobile communication device print data between a mobile communication device and an image forming device may include a first field 1122 that stores a print service request and a second field 1124 that stores a printer-ready object. In another example, a data packet 1100 for communicating mobile communication device print data between a first mobile communication device and one or more second mobile communication devices may include a first field 1122 that stores a print service request and a second field 1124 that stores a non-printer-ready object to be print served by the first mobile communication device on behalf of a second mobile communication device.

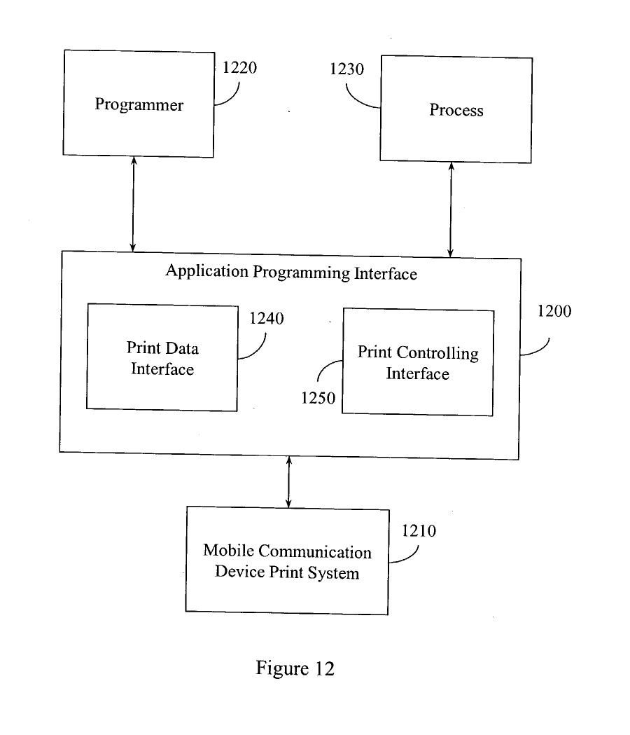

Referring now to FIG. 12, an application programming interface (API) 1200 is illustrated providing access to a mobile communication device print system 1210. The API 1200 can be employed, for example, by programmers 1220 and/or processes 1230 to gain access to processing performed by the system 1210. For example, a programmer 1220 can write a program to access a mobile communication device print system 1210 (e.g., to invoke its operation, to monitor its operation, to access its functionality) where writing a program is facilitated by the presence of the API 1200. Thus, rather than the programmer 1220 having to understand the internals of the mobile communication device print system 1210, the programmer's task is simplified by merely having to learn the interface to the system 1210. This facilitates encapsulating the functionality of the system 1210 while exposing that functionality. Similarly, the API 1200 can be employed to provide data values to the system 1210 and/or retrieve data values from the system 1210. For example, a process 1230 that communicates print-ready objects can provide the print-ready objects to the system 1210 via the API 1200 by, for example, using a function call provided in the print data interface 1240 of the API 1200. Similarly, a programmer 1220 who wants to control the system 1210 can employ a call in the print controlling interface 1250 portion of the API 1200.

Thus, in one example of the API 1200, a set of application program interfaces can be stored on a computer-readable medium. The interfaces can be executed by a logic to gain access to a mobile communication device print system 1210. Interfaces can include, but are not limited to, a first interface 1240 that communicates print data and/or signals with the mobile communication device print system 1210 and a second interface 1250 that communicates control data and/or signals with the system 1210.

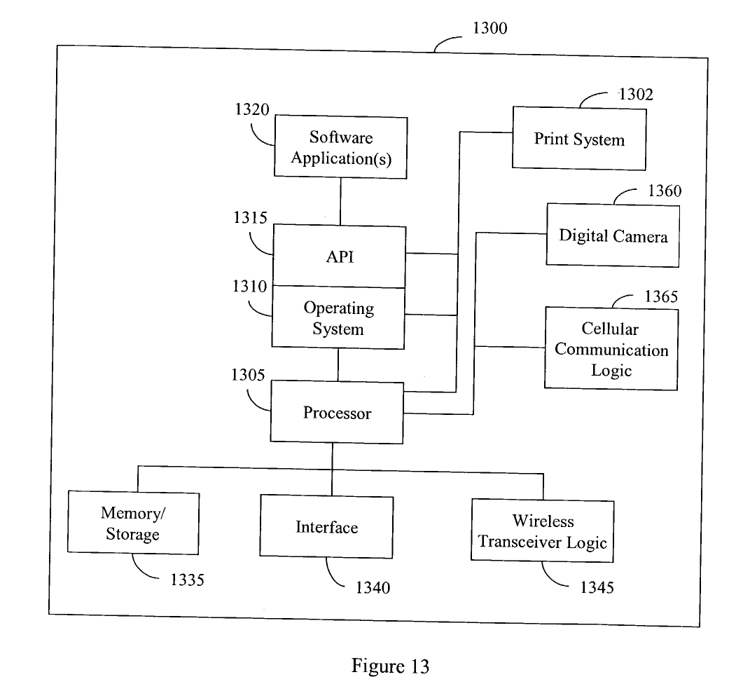

FIG. 13 illustrates an example wireless mobile communication device 1300 that includes a print system 1302. In addition to the print system 1302, the mobile communication device 1300 may include a processing system that has, for example, a processor 1305, an operating system 1310, and an application programming interface (API) 1315 to provide communication between one or more of, a software application 1320, print system 1302, and operating system 1310. The processing system of the mobile device 1300 can be configured to execute a variety of software applications 1320. One such application may implement a print services method for the mobile communications device 1300. The print services method may provide print serving for the mobile communication device 1300 itself and/or one or more external mobile communication devices.

Other components of the mobile device 1300 may include memory and/or storage 1335 that can include a computer-readable medium. The storage 1335 may also include a port that accepts and reads data stored on a removable memory card or other removable computer-readable medium. An interface 1340 can include a display screen, one or more buttons, a pointing device, or other types of devices that can communicate data to a user and receive input from a user. To perform wireless communication, a wireless transceiver logic 1345 is provided. Depending on the wireless communication protocol desired, the transceiver logic 1345 can be configured according to different specifications.

In one example, the wireless protocol is Bluetooth and the transceiver 1345 would include a Bluetooth radio and antenna. Other protocols include IEEE 802.11 and other available wireless protocols. In one example, the wireless transceiver logic 1345 includes a radio frequency transceiver configured to transmit and receive radio frequency signals. Infrared communication can also be employed. The transceiver logic 1345 may be, for example, a microchip in the mobile device 1300 or configured on a removable device like a PCMCIA card (PC card) that can be connected and disconnected to the mobile device 1300 via a connection port or slot. In one example, the mobile device 1300 includes a digital camera 1360 and a cellular communication logic 1365. In this example, the mobile device 1300 may be referred to as a camera-enabled phone.

The systems, methods, objects and so on described herein may be stored, for example, on a computer-readable medium. An example computer-readable medium can store, for example, processor executable instructions for a print services method that includes identifying an image forming device to which a mobile communication device can provide a print-ready object, establishing a communication link between the image forming device and the mobile communication device, transforming a non-print-ready object on the mobile communication device into a print-ready object on the mobile communication device, and transmitting the print-ready object from the mobile communication device to the image forming device. While the above method is described being stored on a computer-readable medium, it is to be appreciated that other methods described herein can also be stored on a computer-readable medium.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on employed in mobile communication device printing. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Gamer, A Dictionary of Modem Legal Usage 624 (2d. Ed. 1995).

What is claimed is:

1. A cellular telephone printing system, comprising:
a discovery logic configured to identify an image forming device to which the system can provide an image forming device ready print job;
a content transforming logic configured to transform a print data into the image forming device ready print job; and
a print managing logic configured to manage providing the image forming device ready print job to the image forming device.

2. The system of claim 1, where the image forming device is a printer.

3. The system of claim 1, where the cellular telephone includes cellular communication logic.

4. The system of claim 1, where the cellular telephone is a camera-enabled mobile phone.

5. The system of claim 1, where the print data is one or more of, a file, a message, an image, an object, and an email.

6. The system of claim 1, where the image forming device ready print job comprises printer-ready bits.

7. The system of claim 1, where the image forming device ready print job comprises printer-ready instructions.

8. The system of claim 1, where the image forming device ready print job is an XHTML file.

9. The system of claim 1, where the discovery logic is configured to identify the image forming device by employing the Bluetooth protocol.

10. The system of claim 1, comprising:
a print monitor logic configured to monitor one or more of, processing performed by the discovery logic, processing performed by the print managing logic, processing performed by the image forming device, a connection between the system and the image forming device, processing performed by the content transforming logic, and the processing of a print job.

11. The system of claim 10, where the print monitor logic is configured to report on one or more of, the transformation of print data to the image forming device ready print job, the transmission of the image forming device ready print job to the image forming device, the processing of the image forming device, the processing performed by the discovery logic, the processing performed by the content transforming logic and the processing performed by the print managing logic.

12. The system of claim 10, where the print monitor logic is configured to control one or more of, the discovery logic, the content transforming logic, the print managing logic, the image forming device, and the connection between the system and the image forming device.

13. The system of claim 12, where the print monitor logic is configured to control one or more of, pausing the image forming device, delaying the delivery of the image forming device ready print job to the image forming device, canceling the delivery of the image forming device ready print job to the image forming device, delaying the processing of the image forming device ready print job by the image forming device, and canceling the processing of the image forming device ready print job by the image forming device.

14. The system of claim 10, comprising:
a user interface configured to manage values for one or more parameters associated with cellular telephone printing.

15. The system of claim 14, where the user interface is configured to manage one or more of, a print data parameter, a content transforming logic parameter, a discovery logic parameter, a print managing logic parameter, a print job parameter, a print monitor logic parameter, an image forming device parameter, and a communication parameter.

16. The system of claim 15, where the print data parameter is related to one or more of, a print data type, a print data name, a print data location, and a print data format.

17. The system of claim 15, where the image forming device parameter is related to one or more of, an image forming device address, an image forming device type, and an image forming device capability.

18. The system of claim 15, where the print job parameter is related to one or more of, a print job size, a print job source, a print job destination, a print job type, a print job format, a print job delivery time, and a print job identifier.

19. The system of claim 15, where the discovery logic parameter is related to one or more of, a discovery protocol, a discovery persistence, a discovery initiating control value, and a discovery control logic identifier.

20. The system of claim 15, where the communication parameter is related to one or more of, a communication protocol, a communication path, a communication type, a communication priority, and a communication speed.

21. The system of claim 15, where the print monitor logic parameter is related to one or more of, identifying a set of components for the print monitor logic to monitor, identifying a set of logics to which the print monitor logic will report, and identifying a set of conditions for triggering a print monitor logic action.

22. The system of claim 1, comprising:
an inter-application communication logic configured to interface between the system and one or more of, an operating system, and an application associated with the cellular telephone.

23. The system of claim 22, where interfacing between the system and one or more of the operating system and the application includes employing one or more functionalities provided by the operating system or application to integrate the cellular telephone printing system with the operating system or the application.

24. The system of claim 23, where the one or more functionalities include one or more of, a cut and paste function, a copy and paste function, a send function, a drag and drop function, a menu function, a dialog function, and an icon presentation function.

25. The system of claim 22, where the application is one or more of, a calendar application, a contacts application, an address book application, a game application, a calculator application, a word processing application, and a spread-sheeting application.

26. The system of claim 10, comprising:
a listener logic configured to receive from an external mobile communication device one or more of, a content data, and a print serve request.

27. The system of claim 26, where one or more of the print monitor logic, the print managing logic, and the content transforming logic are configured to process the content data into a print job pursuant to the print serve request and provide the print job to an image forming device on behalf of the external mobile communication device.

28. The system of claim 26, where the print monitor logic is configured to report a status associated with a print job related to the external mobile communication device to the external mobile communication device with which the print job is related.

29. The system of claim 26, comprising:
a security logic configured to control whether a content data or a print serve request from an external mobile communication device will be accepted.

30. The system of claim 26, where the discovery logic is further configured to perform one or more of, generating a print services advertisement, and accepting from an external mobile communication device a request for a print service advertisement.

31. A method, comprising:
identifying an image forming device to which a cellular telephone can provide a print-ready object;
establishing a communication link between the image forming device and the cellular telephone;
transforming a non-print-ready object on the cellular telephone into a print-ready object on the cellular telephone; and
transmitting the print-ready object from the cellular telephone to the image forming device.

32. The method of claim 31, where the communication link employs the Bluetooth protocol.

33. The method of claim 31, where the communication link is a wireless communication link.

34. The method of claim 33, where the communication link is a bi-directional communication link.

35. The method of claim 31, where the print-ready object is one or more of, printer-ready bits, printer-ready instructions, a PostScript file, an XHTML file, a printer definition language file, and a bitmap.

36. The method of claim 31, where the non-print-ready object is one or more of, a file, an object, an image, a message, and an email.

37. The method of claim 31, where the image forming device is a printer.

38. The method of claim 31, where the transmitting includes wireless transmitting based on Bluetooth protocol.

39. The method of claim 31, where the cellular telephone is a camera-enabled mobile phone.

40. The method of claim 31, comprising:
monitoring one or more of, the communication link, and the transmission of the print-ready object to the image forming device.

41. The method of claim 40, comprising:
providing a monitoring result to one or more of, a user, the cellular telephone, a log, a data store, and a file.

42. The method of claim 31, comprising:
advertising a print server capability.

43. The method of claim 31, comprising:
receiving a request for a print service capability advertisement and, in response to receiving the request, advertising a print server capability.

44. The method of claim 31, where the non-printer-ready object is received from an external mobile communication device.

45. The method of claim 44, where the external mobile communication device is a cellular telephone.

46. The method of claim 44, where the external mobile communication device is a camera-enabled mobile phone.

47. The method of claim 44, comprising:
reporting a monitoring result to the external mobile communication device from which the non-printer-ready object was received.

48. The method of claim 31, comprising:
presenting one or more choices for a parameter via a user interface;
receiving one or more parameter values via the user interface; and
providing the one or more parameter values to one or more of, a mobile communication printing method, and a mobile communicating printing system according to the received parameter values.

49. The method of claim 48, where the parameters concern one or more of, a content selection criteria, a print criteria, and a transmission criteria.

50. The method of claim 49, where the content selection criteria are one or more of, a content name, a content type, a content location, a content size, and a content security level.

51. The method of claim 49, where the print criteria are one or more of, a print priority, a print quality, a print size, a print duplex selector, a print orientation selector, and a number of copies selector.

52. The method of claim 49, where the transmission criteria are one or more of, a transmission priority, a transmission protocol, and a transmission size.

53. The method of claim 31, comprising:
sending one or more signals to one or more of, an operating system on the cellular telephone, and an application on the cellular telephone, where the one or more signals facilitate integrating the method with one or more functionalities provided by the operating system or application.

54. The method of claim 31, comprising:
providing one or more print service data to one or more of, an operating system on the cellular telephone, and an application on the cellular telephone, where the print service data facilitates integrating the method with the operating system or application.

55. A computer-readable medium storing processor executable instructions operable to perform the method of claim 31.

56. An image forming device, comprising:
a logic configured to receive a print service request from a wireless mobile communication device with a print system; and
a memory configured to store one or more of, a printer-ready object received from the wireless mobile communication device with a print system, a non-printer-ready object received from the wireless mobile communication device with a print system, and a status information associated with processing an object received from the wireless mobile communication device with a print system;
where the image forming device is configured to print the printer-ready object or the non-printer-ready object according to the print service request.

57. A set of application programming interfaces embodied on a computer-readable medium for execution by a processor in conjunction with providing a print service for a mobile communication device, comprising:
a first interface configured to communicate a print data to the print service; and
a second interface configured to communicate a print controlling data to the print service.
